(19) United States
(12) Patent Application Publication
(10) Pub. No.: US 2010/0220012 A1
(43) Pub. Date: Sep. 2, 2010

(54) System and method to range using multi-carrier phasing synchronization

(76) Inventor: Ivan Reede, Montreal (CA)

Correspondence Address: TEITELBAUM & MACLEAN, 280 SUNNYSIDE AVENUE, OTTAWA, ON, K1S 0R8, CA

(21) Appl. No.: 11/868,190

(22) Filed: Oct. 5, 2007

Related U.S. Application Data
(60) Provisional application No. 60/828,326, filed on Oct. 5, 2006.

(51) Int. Cl. G01S 1/24

(52) U.S. Cl. 342/387

(57) ABSTRACT

A system and method establishes the time of flight and thereby distance between two transceivers on various media, including but not limited to vacuum, air, electrical wire, optical fiber; using carrier waves sent from one or more transmitters or transceivers to one or more receivers or transceivers. Carriers are arranged to allow the extraction of channel information and maintain acceptable peak to average ratios in an OFDM system.

### PRIORITY

The present application claims priority under 35 USC section 119 based upon application 60/828, 326 which was filed on Oct. 5, 2006.

### FIELD OF THE INVENTION

The present invention relates to measuring distances between a transmitter and receiver.

### BACKGROUND

Ranging in modern communication systems is a serious concern. Regrouped in international conventions, such as the IEEE802, experts form all over the world are presenting various means or combination of means in an attempt to establish the distance between said devices (transmitters, receivers and transceivers) ultimately the location of said devices. One of the methods to obtain or confirm said geographic location of a device is to estimate the distance between said device and a plurality of other devices with a known geographic locations. Apparatuses such as databases, GPS and various other devices are under consideration by the international body of experts. None of the solutions considered up to date appear to be simple, elegant and economical. None of the presented solutions has yet been able to rally some form of consensus of opinion as an acceptable or optimal solution. Yet, E911 requirements under consideration may place location requirements on data communication networks to carry VoIP (voice over Internet protocol) which requires definitive location (and thereby range estimation solutions). In view of the application field, whichever solution is adopted, it must be simple enough for installation by people who currently are able to install, data communication network equipment and economical enough to allow for mass deployment.

For example, conventional “flight time” measurement apparatus, although not external to the communication system in nature, require intricate, high bandwidth, high speed circuits to yield reasonable precision and resolution {i.e. (speed of light)/time methods}. GPS methods, although good at providing location, require the installation of receivers. This may prove to be difficult in practice, where equipment may be installed in the shadow of another building, inside a building or in a location where such means may be inoperable. This is also an additional installation process which complicates and adds cost to the installation.

The devices generally already have the ability to transmit and/or receive a plurality of carriers, either simultaneously, such as in OFDM devices or sequentially, in time.

Below are a few prior art applications.

| Application# | PCT# | Country | Filing Priority | Int Pub# |
|---|---|---|---|---|
| 9410959.2 | PCT/CA1995/000325 | U.K. | Jun. 1, 1994 | WO1995/000325 |
| 9508884.5 | PCT/GB1996.001039 | U.K. | May 2, 1995 | WO1996/035306 |
| 60/421,309 | PCT/US2003/033907 | USA | Oct. 25, 2002 | WO2004/039027 |
| 60/438,601 | ″ | USA | Jan. 07, 2003 | |
| 10/375,162 | ″ | USA | Feb. 25, 2003 | |
| 60/421309 | PCT/US2003/033905 | USA | Oct. 25, 2002 | WO2004/038987 |
| 60/674,038 | ″ | USA | Sep. 29, 2003 | |
| 60/506,174 | — | USA | Sep. 29, 2003 | CA2483117 |
| 2001/69994 | PCT.KR2002/002103 | KR | Nov. 10, 2001 | WO2003/043245 |
| 2002/3204 | — | KR | Jan. 19, 2002 | |
| 506558 | PCT/NZ2001/00173 | NZ | Aug. 25, 2000 | WO2002/023781 |
| 09/252,959 | PCT/US2000/004062 | USA | Feb. 18, 1999 | WO2000/049782 |
| 09/750,804 | — | USA | Dec. 29, 2000 | |
| 60/229,972 | — | USA | Sep. 01, 2000 | |
| P200300052 | PCT/ES2004/000003 | SP | Jan. 10, 2003 | WO2004/064278 |

### SUMMARY

An apparatus to determine flight time and to compute the distance/location:

a transmitter to transmit a signal to be used to determine the flight time and the corresponding distance/location in a transmission medium includes a receiver to receive the signal to be used to determine the flight time and a corresponding distance/location.

The distance/location may be determined by using the propagation properties of the transmission medium, and the receiver may be a multi-tone receiver.

The transmitter may be a multi-tone transmitter, and the distance from the transmitter may be determined by phase warping information.

The receiver may be a QAM64 receiver, and the receiver may be a QAM256 receiver.

The apparatus may include a plurality of transceivers to determine the distance/location and web geometry between the plurality of transceivers based upon propagation properties of the transmission medium, and the transmitter may include a OFDM modulator.

The receiver may include a OFDM demodulator, and the transceivers may use phase warping information between adjacent and non adjacent transceivers.

The transceivers may transmit a signal with a space-time phase correlation to allow recovery of meaningful correlation information at another location, and the phase warping information may be processed in a lumped manner or may be processed in a distributed manner.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a circuit diagram of the present invention.

### DESCRIPTION

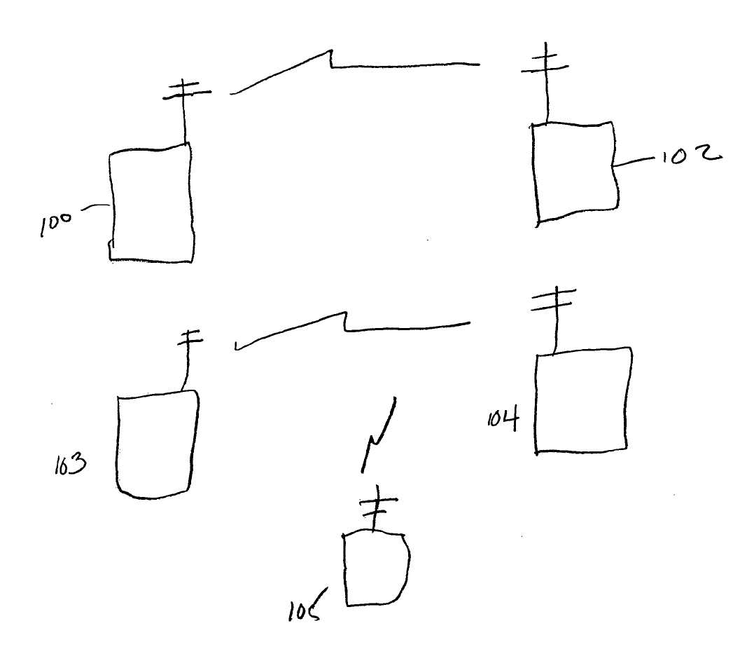

FIG. 1 illustrates a receiver 100 and transmitter 102, and two transceivers 103,104 which may be used to implement aspects of the present invention. One aspect of this invention relates to apparatuses, given multiple carrier transmission, whether simultaneous or sequential in nature, to resolve a ranging value (the length of a path in a media) between a transceiver ‘t’ 103 on one hand and another transceiver ‘r’ 104 on the other hand, with reasonable precision and at a low added cost in a reasonably low bandwidth channel such as a TV channel.

Assume a plurality of carriers are simultaneously or sequentially sent over a medium (which may be wire, fiber, air, vacuum or other medium) by a device ‘t’ 103, located at space-time point ‘t’, each carrier having a distinct frequency. If a receiver ‘r’ 104 located at space-time point ‘r’ phase locks to the longest wavelength carrier, the phase difference between the signal at point ‘t’ and the signal at point ‘r’ can be equated to a course—long range flight time proportional to the propagation time of the signal from ‘r’ 104 to ‘t’ 103 along the medium.

Transmitting a second carrier with a known phase relationship to the first carrier, at a higher frequency, allows the receiver 100 to refine the flight time, estimate by aligning both waves to the known initial phase relationship (such as the beginning and the end of an OFDM symbol).

Phase warping has been viewed as a useless non-informational property that is an impairment to telecommunications and as a nuisance that should be compensated for (and perhaps even essentially eliminated) in multi-carrier systems. This invention stems from the recognition that this warp (a twist or curve that has developed in something that was originally flat) “nuisance” is in fact rich with channel characterizing information, including but not limited to the signal's propagation distance. This invention capitalizes on the fact that any phase sensitive receiver apparatus, such as quadrature amplitude receivers already acquire phase with a given resolution. One aspect of this invention lies in the processing of this information to acquire propagation time and therefore ranging information. Therefore, using the teachings of the present invention, practically no added hardware is required to acquire the information needed to apply this aspect of the invention.

A plurality of reception apparatuses 100 may allow the simultaneous or sequential reception of two or more carriers and to measure their relative or absolute phase difference at a moment in time, or to synchronize to them (for example, of simultaneous carrier transmission systems) or their relative or absolute subsequent phase difference (for example, devices which exhibit carrier phase memory such a phase lock loops from one carrier wave to another). Other apparatus may either simultaneously or sequentially receive and measure phase of a plurality of carrier waves and to relate them one to another and to a form of time stamping clock.

The following implementation example will be used to illustrate some of the aspects of this invention's operating principles. This example is based on transceivers 103, 104 using OFDM symbols, capable of transmitting approximately 2000 tones or carrier waves in a 6 MHz channel at a spectral inter-carrier spacing of 3000 Hz. One aspect of this implementation example also shows that all the ranging carrier tones are sine waves transmitted with their zero value at the beginning and at the end of the symbol period. This has the great advantage of minimizing the peak to average ration of the transmitted signal and allows other data to be sent over the carriers that are not used for ranging purposes.

Let c=299792458 m/s be the speed of light in the example medium (space), f₁ be the first carrier and f₂ be the second, as per table 2. In this example implementation, the output signal may be decomposed as the sum of two thousand orthogonal waves (table 2 depicts a few selected carriers). Wave, f₁ has a longer wavelength than f₂ as the wavelength is c/f and this is invariant. One of the aspects of this invention is the discovery of a mechanism which is invariant, even when the tones are up-converted to a set of RF carrier waves or down-converted to an IF or baseband level, whatever be the RF frequency of the carrier wave set (or channel). Let the tones be issued as part of an OFDM symbol where the IFFT of the transmitter 102 was instructed to output both tones with a zero phase offset at the beginning and end of the burst. (Note: Any tone pair may be used, the tones selected here for illustrative purposes only, and their phases may be arbitrary, provided they are known by the transmitter 102 and receiver 100.)

When the receiver 100 locks onto carrier tone f₁, it will be able to lock with a phase resolution proportional to ifs phase discrimination ability. Assuming that the receiver apparatus 100 is able to receive QAM 64 symbols, then as per table 1, it should at least be able to phase lock to the fᵢ QAM64 within approximately 15°. This 15° uncertainty translates into a large time of arrival uncertainty as depicted in the rightmost column of table 2. Note that other reception and demodulation apparatuses have different resolution is within the scope of the present invention but this in no way denies the ranging principles of this invention.

It is the object of this invention to significantly increase the precision of the received time of flight without reverting to very large bandwidth signals. When the receiver ‘r’ 104 will receive carrier tone f₂, it will need to refine its phase lock such as to align both tones so that it can also demodulate both f₁ and f₂ QAM64 symbols. Doing so will reduce the time of arrival uncertainty by a factor of two. Another aspect of this invention is that having received and demodulated the first tone will have maximized the resolvable range (in this case to approximately 100 km before the phase wraps)360° without losing the total range capability.

Receiving and demodulating tones with further spectral separation will further refine the time of arrival precision. Locking it's internal time reference to this precise reference, and provided a short time between the reception of the symbol's waves and a response to the symbol (short time in terms of receiver time base stability), the transceiver. ‘r’ 104 may now transmit back to transceiver ‘t’ 103. Transceiver ‘t’, upon reception and alignment of the symbol constellations, may now compare the constellation phases to his original transmission and determine from this the actual back and forth flight time, provided device ‘r’ 104 (a) informed device ‘t’ 103 of the precise time interval it took to respond or (b) provided this time interval was known a priori by the devices ‘t’ 103 and ‘r’ 104. Since the flight time is the sum of the time from ‘t’ to ‘r’ and then the response from ‘r’ to ‘t’, the available precision in this implementation example is twice that depicted in table 2 or approximately 1 meter for a 6 MHz carrier separation/total bandwidth.

Other data acquisition processes may be used to achieve the same intended invention. For example, one may elect to use an apparatus where the receiver does not “phase lock” to the incoming signal but rather decodes the incoming signal ‘as is’ and passes ‘whatever’ it received for post processing. In such case, this post process stage will in some form acquire the “phase lock” timing information and may be able to relay this back to the signal originator in a timely manner, thereby allowing the originator to estimate with required or desired precision, the flight time of the carrier tones from ‘t’ 103 to ‘r’ 104. In fact, once the information has been acquired, it may be transmitted to one or a plurality of devices that collectively, embody the processing apparatus to extract and arrive to the subject matter of this invention. The processing apparatus and may also be distributed amongst a collectivity of processing units, such as in a network, to further reduce the cost of implementation and possibly share or defer the processing load and implementation cost and ultimately, convert the ranging information this obtained to location information. Thus, the embodiment of the current invention may be distributed through a number of devices and not necessarily be lumped into a single device and extends from ranging estimation to actual location estimation using location algorithms and the information herein described.

Another aspect of this invention is to synchronize the plurality of carriers of an OFDM system in an opportunistic amplitude and phasing arrangement to allow the received signature to reveal channel sounding information and thereby allow further processing to extract characteristics of the transmission medium between the transceivers. For example, a group of carriers may be simultaneously transmitted to form a steep rise/fall time edge functions (such as a step function approximation, short duration Dirac function approximation, raised sine or cosine functions, etc. . . . ) and the received signature may be processed locally or remotely, in a lumped or distributed fashion, revealing one or a plurality of channel parameters and characteristics (such as range, multi-path delays and amplitudes, fading, Doppler shift, etc. . . . ). Channel characteristics that may be collected include but are not limited to conversion by channel multi-path or a transmitted step into a distorted staircase where each successive sub-steps and the slopes representing one or a plurality of paths in the case of a multi-path medium, the first step being the caused by the reception of the most direct ray and the next ones being reflected or refracted rays. Furthermore, it is an aspect of this invention that various carrier combinations may be sent, either simultaneously or sequentially, to obtain coarse resolution results and thereafter finer and finer resolution until the desired detail is achieved.

Given adequate processing apparatus, a collectivity of such devices may reveal a valuable signal propagation map and a “radar image” including reflectors, refractors, scatterers, of the medium or of a geographical area in cases where the medium covers a given terrain and this may be enhanced if the devices may transmit or receive with directional discrimination.

The choice of carrier tones in this example may be totally arbitrary and that the same or results of similar value may be achieved with other sets of tones provided their spectral separation allows for the required resolution and precision and their spectral spacing provides sufficient proximity to overcome the limitations in phase detection precision of the receiver apparatus and the cyclic nature of the tone phases (wraps every 360° when using sine waves). These tones may be substantially optimized to coincide with tones already sent for other purposes, such as the tones used in current OFDM systems to allow the receiver to compensate for constellation tilt and warp that may be caused by the media or other artifacts.

It is another aspect of this invention that transceiver ‘t’ 103 may perform the above described ranging function but that this function may also be performed with the assistance of third party devices. As such transceiver ‘t’ 103 may send the ranging signal to transceiver “r’ 104. It may also send a command to transceiver ‘s’ 105, a third party, to listen and lock to the response of ‘r’ 104 to ‘t’ 103 and to then, make a response from ‘s’105 to ‘t’103, locked to the response from ‘r’ 104 to ‘t’ 103 such as to allow the system to map the ranges ‘r’ 104 to ‘s’ 105 in addition to the range ‘r’ 104 to ‘t’ 103. By doing this, with one or a plurality of ‘s’ transceivers, this aspect of the invention allows the collection of additional information in plurality of dimensions, allowing the system to build, amongst others, a multi-dimensional map of the network, the distances between transceivers, the obstacles and terrain effects between transceivers, multi-path propagation properties of the transmission media, without neglecting the possibility of ranging transceivers which may be out of direct reach or where direct reach may not yield the most precise ranging information.

The present invention includes means to finely resolve flight time and thereby compute the distance/location from one or a plurality of transmitters to a one or a plurality of receivers using the propagation properties of the transmission medium and a plurality of carriers and a means by which a multi-carrier or multi-tone QAM4 receiver may resolve the distance from a multi-carrier or multi-tone transmitter using the phase warping information available at the receiver.

The present invention includes means by which a multi-carrier or multi-tone QAMI6 receiver may resolve the distance from a multi-carrier or multi-tone transmitter using the phase warping information available at the receiver and means by which a multi-carrier or multi-tone QAM64 receiver may resolve the distance from a multi-carrier or multi-tone transmitter using the phase warping information available at the receiver.

The present invention includes means by which a multi-carrier or multi-tone QAM2S6 receiver may resolve the distance from a multi-carrier or multi-tone transmitter using the phase warp information available at the receiver and means to compute the distance/location and the web geometry between a plurality of transceivers to a plurality of transceivers using the propagation properties of the transmission medium and a plurality of carriers.

The present invention includes means by which a transceiver can request a second transceiver ranging/location information about a third transceiver and means of using a multi-carrier transmitter, such as a transmitter with and OFDM modulator and multi-carrier receiver, such as a receiver with an OFDM demodulator to effect ranging/location measurements and calculations.

The present invention includes means of using the phase warping information between adjacent and non-adjacent carriers to compute the propagation time of the carriers and means of transmitting a plurality of carriers which a known space-time phase correlation to allow recovery of meaningful correlation information at another space-time point.

The present invention includes means of processing the collected warpage signature locally or remotely in a lumped or in distributed fashion and means of processing the collected channel response locally or remotely in a lumped or in a distributed fashion

The present invention includes means of collecting the channel response to allow for processing and means of collecting the warpage signature information for processing and a means of transmitting the collected information.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

| | | | | | | | | | | | | | | | | |
|---|---|---|---|---|---|---|---|---|---|---|---|---|---|---|---|---|
| 135° | | 127° | | 117° | | 104° | | 90° | | 76° | | 63° | | 53° | | 45° |
| | 9.9 | | 8.6 | | 7.62 | | 7.07 | | 7.07 | | 7.62 | | 8.6 | | 9.9 | |
| | 135° | | 125° | | 113° | | 98° | | 82° | | 67° | | 57° | | 45° | |
| | −7, +7 | | −5, +7 | | −3, +7 | | +1, +7 | | +1, +7 | | +3, +7 | | +5, +7 | | +7, +7 | |
| 143° | | 135° | | 124° | | 108° | | 90° | | 72° | | 56° | | 45° | | 37° |
| | 8.6 | | 7.07 | | 5.83 | | 5.1 | | 5.1 | | 5.83 | | 7.07 | | 8.6 | |
| | 147° | | 135° | | 121° | | 101° | | 79° | | 59° | | 45° | | 36° | |
| | −7, +5 | | −5, +5 | | −3, +5 | | −1, +5 | | +1, +5 | | +3, +5 | | +5, +7 | | +7, +5 | |
| 153° | | 146° | | 135° | | 117° | | 90° | | 63° | | 45° | | 34° | | 27° |
| | 7.62 | | 5.83 | | 4.24 | | 3.16 | | 3.16 | | 4.24 | | 5.83 | | 7.62 | |
| | 157° | | 149° | | 135° | | 108° | | 72° | | 45° | | 31° | | 23° | |
| | −7, +3 | | −5, +3 | | −3, +3 | | −1, +3 | | +1, +3 | | +3, +3 | | +5, +3 | | +7, +3 | |
| 166° | | 162° | | 153° | | 135° | | 90° | | 45° | | 27° | | 18° | | 14° |
| | 7.07 | | 5.1 | | 3.16 | | 1.41 | | 1.41 | | 3.16 | | 5.1 | | 7.07 | |
| | 172° | | 169° | | 162° | | 135° | | 45° | | 18° | | 11° | | 8° | |
| | −7, +1 | | −5, +1 | | −3, +1 | | −1, +1 | | +1, +1 | | +3, +1 | | +5, +1 | | +7, +1 | |
| 180° | | 180° | | 180° | | 180° | | n/a | | 0° | | 0° | | 0° | | 0° |
| | 7.07 | | 5.1 | | 3.16 | | 1.41 | | 1.41 | | 3.16 | | 5.1 | | 7.07 | |
| | 188° | | 191° | | 198° | | 225° | | 315° | | 342° | | 349° | | 352° | |
| | −7, −1 | | −5, −1 | | −3, −1 | | −1, −1 | | +1, −1 | | +3, −1 | | +5, −1 | | +7, −1 | |
| 194° | | 198° | | 206° | | 225° | | 270° | | 315° | | 334° | | 342° | | 346° |
| | 7.62 | | 5.83 | | 4.24 | | 3.16 | | 3.16 | | 4.24 | | 5.83 | | 7.62 | |
| | 203° | | 211° | | 225° | | 252° | | 288.° | | 315° | | 329° | | 337° | |
| | −7, −3 | | −5, −3 | | −3, −3 | | −1, −3 | | +1, −3 | | +3, −3 | | +5, −3 | | +7, −3 | |
| 206° | | 214° | | 225° | | 243° | | 270° | | 297° | | 315° | | 326° | | 333° |
| | 8.6 | | 7.07 | | 5.83 | | 5.1 | | 5.1 | | 5.83 | | 7.07 | | 8.6 | |
| | 216° | | 225° | | 239° | | 259° | | 281° | | 301° | | 315° | | 325° | |
| | −7, −5 | | −5, −5 | | −3, −5 | | −1, −5 | | +1, −5 | | +3, −5 | | +5, −3 | | +7, −3 | |
| 217° | | 225° | | 236° | | 252° | | 270° | | 288° | | 304° | | 315° | | 323° |
| | 9.9 | | 8.6 | | 7.62 | | 7.07 | | 7.07 | | 7.62 | | 8.6 | | 9.9 | |
| | 223° | | 237° | | 247° | | 262° | | 278° | | 293° | | 306° | | 315° | |
| | −7, −7 | | −5, −7 | | −3, −7 | | −1, −7 | | +1, −7 | | +3, −7 | | +5, −7 | | +7, −7 | |
| 225° | | 233° | | 243° | | 256° | | 270° | | 284° | | 297° | | 307° | | 315° |

TABLE 2
Overall example summary

| | tone | | |
|---|---|---|---|
| | | | 15° flight |
| carrier | Frequency (Hz) | Wavelength (m) | time uncertainty (m) |
| f1 | 3,000 | 99930.819333 | 4163.78 |
| f2 | 6,000 | 49965.409666 | 2081.89 |
| f4 | 12,000 | 24982.704833 | 1040.95 |
| f8 | 24,000 | 12491.352417 | 520.47 |
| f16 | 48,000 | 6245.676208 | 260.24 |
| f32 | 96,000 | 3122.838104 | 130.12 |
| f64 | 192,000 | 1561.419052 | 65.06 |
| f128 | 384,000 | 780.709526 | 32.53 |
| f256 | 768,000 | 390.354763 | 16.26 |
| f512 | 1,536,000 | 195.177381510 | 8.13 |
| f102 | 2,997,000 | 100.030850184 | 4.17 |
| f1999 | 5,997,000 | 49.990404869 | 2.08 |

1) An apparatus to determine flight time and to compute the distance/location, comprising:
a transmitter to transmit a signal to be used to determine the flight time and the corresponding distance/location in a transmission medium;
a receiver to receive the signal to be used to determine the flight time and a corresponding distance/location;
wherein the distance/location is determined by using the propagation properties of the transmission medium.

2) An apparatus to determine flight time and to compute the distance/location as in claim 1, wherein the receiver is a multi-tone receiver.

3) An apparatus to determine flight time and to compute the distance/location as in claim 1, wherein the transmitter is a multi-tone transmitter.

4) An apparatus to determine flight time and to compute the distance/location as in claim 1, wherein the distance from the transmitter is determined by phase warping information.

5) An apparatus to determine flight time and to compute the distance/location as in claim 1, wherein the receiver is a QAM64 receiver.

6) An apparatus to determine flight time and to compute the distance/location as in claim 1, wherein the receiver is a QAM256 receiver.

7) An apparatus to determine flight time and to compute the distance/location as in claim 1, wherein the apparatus includes a plurality of transceivers determine the distance/location and web geometry between the plurality of transceivers based upon propagation properties of the transmission medium.

8) An apparatus to determine flight time and to compute the distance/location as in claim 1, wherein the transmitter includes a OFDM modulator.

9) An apparatus to determine flight time and to compute the distance/location as in claim 1 wherein the receiver includes a OFDM demodulator.

10) An apparatus to determine flight time and to compute the distance/location as in claim 7, wherein the transceivers use phase warping information between adjacent and non adjacent transceivers.

11) An apparatus to determine flight time and to compute the distance/location as in claim 7, wherein the transceivers transmit a signal with a space-time phase correlation to allow recovery of meaningful correlation information at another location.

12) An apparatus to determine flight time and to compute the distance/location as in claim 4, wherein the phase warping information is processed in a lumped manner.

13) An apparatus to determine flight time and to compute the distance/location as in claim 4, wherein the phase warping information is processed in a distributed manner.
